(19) United States
(12) Patent Application Publication
(10) Pub. No.: US 2007/0216606 A1
(43) Pub. Date: Sep. 20, 2007

(54) Plasma display panel driving

(75) Inventors: Dooyong Hwang, Yongin-si (KR); Gyungrae Kim, Dalseo-gu (KR)

Correspondence Address: KED & ASSOCIATES, LLP, P.O. Box 221200, Chantilly, VA, 20153-1200, US

(73) Assignee: LG Electronics Inc.

(21) Appl. No.: 11/634,258

(22) Filed: Dec. 6, 2006

(30) Foreign Application Priority Data
Mar. 14, 2006 (KR) 10-2006-0023730

(51) Int. Cl. G09G 3/28

(52) U.S. Cl. 345/67

(57) ABSTRACT

A plasma display panel and a method of driving the same are disclosed. The method of driving the plasma display panel includes applying a first pulse to the scan electrode during a reset period, applying a third pulse wherein the third pulse comprises a rising period and a maintaining period, and the rising period ranges from about 75 ns to about 800 ns, applying a fourth pulse, and a voltage difference between the lowest voltage level of the fourth pulse and the lowest voltage level of the second pulse ranges from 5V to 50V, applying a plurality of pulses to the scan electrode, and wherein the upper dielectric layer and the lower dielectric layer have Pb whose amount is equal to or less than 1000 ppm, respectively.

This Nonprovisional application claims priority under 35 U.S.C. §119(a) on Patent Application No. 10-2006-0023730 filed in Korea on Mar. 14, 2006 the entire contents of which are hereby incorporated by reference.

### BACKGROUND

1. Field

This document relates to a plasma display panel.

2. Description of the Related Art

In recent years, flat panel displays such as liquid crystal displays (LCD), field emission displays (FED), PDPs, and the like have been actively developed. The PDP is advantageous over the other flat panel displays in regard to its offers high luminance, high luminous efficiency, and wide view angle, and accordingly it is favorable for making large-scale screens of more than 40 inches as a substitute for the conventional cathode ray tube (CRT). The PDP is a flat panel display that uses plasma generated by gas discharge to display characters or images, and it includes, according to its size, more than several scores to millions of pixels arranged in a matrix pattern. Such a PDP is classified into a direct current (DC) type and an alternating current (AC) type according to its discharge cell structure and the waveform of the driving voltage applied thereto. The DC PDP has electrodes exposed to a discharge space to allow DC flowing through the discharge space while the voltage is applied, and thus requires a resistance for limiting the current. On the other hand, the AC PDP has electrodes covered with a dielectric layer that forms a capacitance component to limit the current and protects the electrodes from the impact of ions during a discharge, and is thus superior to the DC PDP in regard to a long lifetime.

### SUMMARY

In one general aspect, a method of driving a plasma display panel comprises a front substrate on which a scan electrode, a sustain electrode and an upper dielectric layer are formed, and a rear substrate on which an address electrode intersecting the scan electrode and the sustain electrode and a lower dielectric layer are formed, during a frame comprising applying a first pulse in which a voltage varies with time until reaching a first voltage level to the scan electrode during a reset period, applying a second pulse, in which a voltage varies with time until reaching a second voltage level to the scan electrode during the reset period, after applying the first pulse, the second pulse having a polarity opposite to a polarity of the first pulse, applying a third pulse corresponding to a data pulse to the address electrode through a first circuit comprising an inductor during an address period which follows the reset period, wherein the third pulse comprises a rising period and a maintaining period, and the rising period ranges from about 75 ns to about 800 ns, applying a fourth pulse to the scan electrode during the address period, wherein a portion of the fourth pulse is overlapped with at least a portion of the third pulse, the lowest voltage level of the fourth pulse is lower than the lowest voltage level of the second pulse, and a difference between the lowest voltage level of the fourth pulse and the lowest voltage level of the second pulse ranges from 5V to 50V, applying a plurality of pulses to the scan electrode through a second circuit comprising at least one inductor during a sustain period for emitting light, and applying a plurality of pulses to the sustain electrode through a third circuit comprising at least one inductor during the sustain period, wherein a Pb content of the upper dielectric layer and the lower dielectric layer is equal to or less than 1000 ppm.

In another aspect, a plasma display panel included in a PDP television set comprising or electrically connected to a hard disk drive for storing video data and audio data, comprises a scan electrode where a first pulse is applied, wherein the first pulse has a voltage varying with time until reaching a first voltage level during a reset period, thereafter, a second pulse is applied wherein the second pulse has a voltage varying with time until reaching a second voltage level, a fourth pulse is applied during an address period, and a plurality of pulses are applied through a second circuit comprising at least one inductor during a sustain period for emitting light, an address electrode where a third pulse corresponding to a data pulse is applied through a first circuit comprising an inductor during the address period, wherein the third pulse comprises a rising period and a maintaining period, and the rising period ranges from about 75 ns to about 800 ns, and a sustain electrode where a plurality of pulses are applied through a third circuit comprising at least one inductor during the sustain period, wherein a polarity of the first pulse is opposite to a polarity of the second pulse, a portion of the fourth pulse is overlapped with at least a portion of the third pulse, the lowest voltage level of the fourth pulse is lower than the lowest voltage level of the second pulse, and a difference between the lowest voltage level of the fourth pulse and the lowest voltage level of the second pulse ranges from 5V to 50V.

### BRIEF DESCRIPTION OF THE DRAWINGS

The embodiment of the invention will be described in detail with reference to the following drawings in which like numerals refer to like elements.

FIGS. 1a and 1b illustrate a data pulse according to a method of driving a related art plasma display panel;

FIG. 2 illustrates a frame for representing gray level of an image in a method of driving a plasma display panel according to an embodiment of the present invention;

FIG. 3 illustrates a driving waveform of a frame in the method of driving the plasma display panel according to the embodiment of the present invention;

FIGS. 4a and 4b are a diagram for explaining in detail a fifth pulse;

FIG. 5 is a diagram for explaining in detail a third pulse;

FIG. 6 is a diagram for explaining in detail a fourth pulse;

FIG. 7 illustrates an example of the structure of the plasma display panel to which the driving method according to the embodiment of the present invention is applied;

FIG. 8 illustrates the structure of each of a scan electrode and a sustain electrode;

FIGS. 9a to 9c illustrate another structure of each of the scan electrode and the sustain electrode;

FIG. 10 illustrates a bus electrode;

FIG. 11 illustrates the scan electrode or the sustain electrode comprising a bus electrode;

FIGS. 12a and 12b illustrate the structure of a black layer for preventing the generation of reflection light caused by the bus electrode;

FIGS. 13a to 13c illustrate another structure of the black layer;

FIG. 14 illustrates a front substrate of the plasma display panel to which the driving method according to the embodiment of the present invention is applied;

FIGS. 15a and 15b illustrate a method of manufacturing the plasma display panel using the front substrate with the different thickness;

FIG. 16 illustrates a function of a depressed portion;

FIG. 17 illustrates a case where a film-type filter is formed on the front substrate of the plasma display panel to which the driving method according to the embodiment of the present invention is applied;

FIG. 18 illustrates an example of the configuration of a circuit comprising an inductor having an energy recovery function;

FIGS. 19a to 19e illustrate an operation of the circuit comprising the inductor of FIG. 18; and

FIG. 20 illustrates a PDP television set comprising the plasma display panel to which the driving method according to the embodiment of the present invention is applied.

### DETAILED DESCRIPTION OF PREFERRED EMBODIMENTS

Embodiments of the present invention will be described in a more detailed manner with reference to the drawings.

In a general plasma display panel, a phosphor layers is formed within discharge cells partitioned by a barrier rib. A plurality of electrodes, for example, a scan electrode, a sustain electrode and an address electrode are formed in the plasma display panel.

A driving pulse is applied to the discharge cell through these electrodes.

A discharge occurs by the driving pulse applied to the discharge cell. When the discharge occurs by the driving pulse within the discharge cell, a discharge gas filled in the discharge cell generates vacuum ultra-violet rays, which thereby cause a phosphor formed inside the discharge cell to emit light. The light-emission of the phosphor generates visible light, and thus an image is displayed.

A reset discharge, an address discharge, a sustain discharge, and the like, occur within the discharge cell of the plasma display panel.

The reset discharge initializes all the discharge cells. The address discharge selects a discharge cell where the sustain discharge is to occur. The sustain discharge is a display discharge for displaying an image on the screen.

The address discharge occurs by a data pulse applied to the address electrode and a scan pulse applied to the scan electrode.

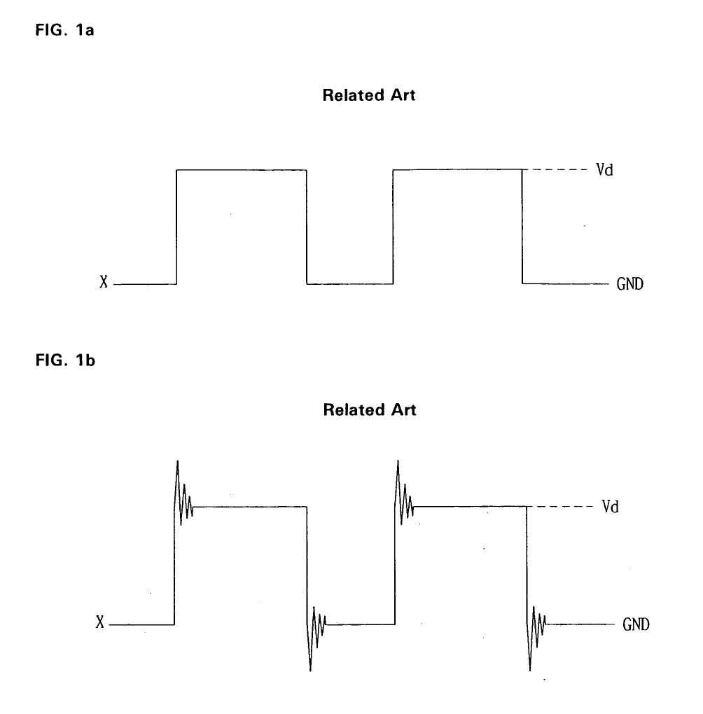

FIGS. 1a and 1b illustrate a data pulse according to a method of driving a related art plasma display panel.

As illustrated in FIG. 1a, the data pulse according to the method of driving the related art plasma display panel abruptly rises from a ground level voltage to a data voltage Vd, and abruptly falls from the data voltage Vd to the ground level voltage.

As illustrated in FIG. 1b, since the data pulse abruptly rises and falls as illustrated in FIG. 1a, a noise and electro magnetic interference (EMI) are caused by coupling effect of the data pulse between the adjacent address electrodes in a rising time point and a falling time point of a voltage of the data pulse.

In an embodiment of the present invention, a method of driving a plasma display panel comprising a front substrate on which a scan electrode, a sustain electrode and an upper dielectric layer are formed, and a rear substrate on which an address electrode intersecting the scan electrode and the sustain electrode and a lower dielectric layer are formed, during a frame comprising applying a first pulse in which a voltage varies with time until reaching a first voltage level to the scan electrode during a reset period, applying a second pulse, in which a voltage varies with time until reaching a second voltage level to the scan electrode during the reset period, after applying the first pulse, the second pulse having a polarity opposite to a polarity of the first pulse, applying a third pulse corresponding to a data pulse to the address electrode through a first circuit comprising an inductor during an address period which follows the reset period, wherein the third pulse comprises a rising period and a maintaining period, and the rising period ranges from about 75 ns to about 800 ns, applying a fourth pulse to the scan electrode during the address period, wherein a portion of the fourth pulse is overlapped with at least a portion of the third pulse, the lowest voltage level of the fourth pulse is lower than the lowest voltage level of the second pulse, and a difference between the lowest voltage level of the fourth pulse and the lowest voltage level of the second pulse ranges from 5V to 50V, applying a plurality of pulses to the scan electrode through a second circuit comprising at least one inductor during a sustain period for emitting light, and applying a plurality of pulses to the sustain electrode through a third circuit comprising at least one inductor during the sustain period, wherein the upper dielectric layer and the lower dielectric layer have Pb whose amount is equal to or less than 1000 ppm, respectively.

A fifth pulse may be applied to the sustain electrode during the application of the first pulse in the reset period.

The fifth pulse may have a negative voltage level.

The fifth pulse may have a voltage varying with time.

The voltage of the fifth pulse may remain constant.

At least one of the plurality of pulses applied to the sustain electrode during the sustain period may be substantially synchronized with at least one of the plurality of pulses applied to the scan electrode during the sustain period.

The scan electrode may comprise a projecting portion. The projecting portion may comprise a first portion, a second portion wider than a horizontal width of the first portion, and a third portion wider than the horizontal width of the second portion.

The width of at least one of the first portion or the second portion gradually may widen toward the middle portion of a discharge cell.

The scan electrode may comprise a bus electrode.

An inner surface of the front substrate may comprise a portion with a different thickness.

A film-type filter may be formed on an external surface of the front substrate.

A black layer may be formed between the scan electrodes, or between the sustain electrodes, or between the scan electrode and the sustain electrode.

A portion of the scan electrode and a portion of the sustain electrode may overlap the black layer.

A dielectric layer comprising a portion with a different thickness may be formed on the inner surface of the front substrate.

At least one of the first, second or third circuits may have an energy recovery function.

The plasma display panel may further comprise a barrier rib, and the barrier rib may have Pb whose amount is equal to or less than 1,000 ppm.

In the embodiment of the present invention, a plasma display panel included in a PDP television set comprising or electrically connected to a hard disk drive for storing a video data and an audio data, comprising a scan electrode where a first p pulse is applied, wherein the first pulse has a voltage varying with time until reaching a first voltage level during a reset period, thereafter, a second pulse is applied wherein the second pulse has a voltage varying with time until reaching a second voltage level,a fourth pulse is applied during an address period, and a plurality of pulses are applied through a second circuit comprising at least one inductor during a sustain period for emitting light, an address electrode where a third pulse corresponding to a data pulse is applied through a first circuit comprising an inductor during the address period, wherein the third pulse comprises a rising period and a maintaining period, and the rising period ranges from about 75 ns to about 800 ns, and a sustain electrode where a plurality of pulses are applied through a third circuit comprising at least one inductor during the sustain period, wherein a polarity of the first pulse is opposite to a polarity of the second pulse, a portion of the fourth pulse is overlapped with at least a portion of the third pulse, the lowest voltage level of the fourth pulse is lower than the lowest voltage level of the second pulse, and a difference between the lowest voltage level of the fourth pulse and the lowest voltage level of the second pulse ranges from 5V to 50V.

The scan electrode may comprise a projecting portion. The projecting portion may comprise a first portion, a second portion wider than a horizontal width of the first portion, and a third portion wider than the horizontal width of the second portion.

The scan electrode may comprise a bus electrode.

Hereinafter, exemplary embodiments of the present invention will be described in detail with reference to the attached drawings.

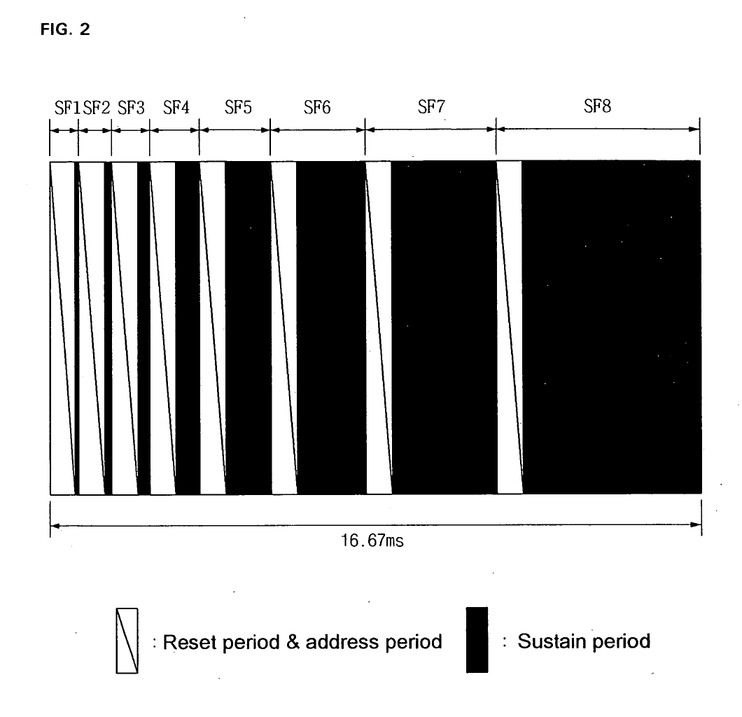

FIG. 2 illustrates a frame for representing gray level of an image in a method of driving a plasma display panel according to an embodiment of the present invention.

As illustrated in FIG. 2, a frame in the plasma display panel is divided into several subfields having a different number of emission times. Although it is not illustrated in the drawings, each of the subfields is subdivided into a reset period for initializing all discharge cells, an address period for selecting discharge cells to be discharged and a sustain period for representing gray scale in accordance with the number of discharges.

For example, if an image with 256-level gray scale is to be displayed, a frame period (for example, 16.67 ms) corresponding to 1/60 sec is divided into eight subfields SF1 to SF8 as illustrated in FIG. 2. Each of the eight subfields SF1 to SF8 is subdivided into a reset period, an address period and a sustain period.

The duration of the reset period in a subfield is equal to the duration of the reset periods in the remaining subfields. The duration of the address period in a subfield is equal to the duration of the address periods in the remaining subfields.

Gray level weight of a subfield comprising the following sustain period may be set by controlling the number of sustain pulses applied during the sustain period. In other words, each of the subfields may be set to predetermined gray level weight using the sustain period. For example, gray level weight of a first subfield is set to 2⁰, and gray level weight of a second subfield is set to 2¹. In other words, gray level weight of each of the subfields may be set to increase gray level weight of each of the subfields in a ratio of 2ⁿ (where, n=0, 1, 2, 3, 4, 5, 6, 7). Gray level of various images is achieved by controlling the number of sustain pulses applied during the sustain period of each of the subfields in accordance with gray level weight of each of the subfields.

The plasma display panel according to the embodiment of the present invention uses a plurality of frames to display an image during 1 second. For example, 60 frames are used to display an image during 1 second.

The explanation was given of an example of the frame comprising 8 subfields in FIG. 2. However, the number of subfields included in a frame may variously change. For example, a frame may comprise 12 subfields or 10 subfields.

Image quality of an image displayed on the plasma display panel, which represents gray level of the image using the frame, may depend on the number of subfields included in the frame. In other words, when a frame includes 12 subfields, gray level of 2¹¹ images can be represented. When a frame includes 8 subfields, gray scale of 2⁷ images can be represented.

The subfields of a frame are arranged in increasing order of gray level weight in FIG. 2. However, the subfields may be arranged in decreasing order of gray level weight. Further, the subfields may be arranged irrespective of gray level weight.

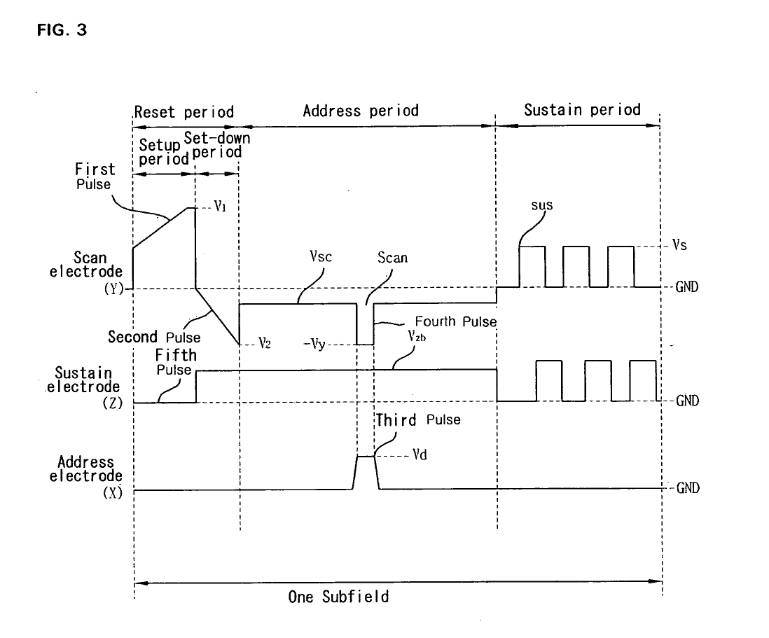

FIG. 3 illustrates a driving waveform of a frame in the method of driving the plasma display panel according to the embodiment of the present invention.

As illustrated in FIG. 3, a first pulse in which a voltage varies with time until reaching a first voltage level V1 is applied to a scan electrode Y during a reset period. For example, the first pulse which gradually rises to the first voltage level in the form of ramp-up, is applied to the scan electrode Y during a setup period of the reset period.

The first pulse generates a weak dark discharge, i.e., setup discharge within the discharge cell. This results in wall charges being accumulated within a discharge cell.

It is preferable that a fifth pulse is further applied to a sustain electrode Z during the application of the first pulse in the reset period.

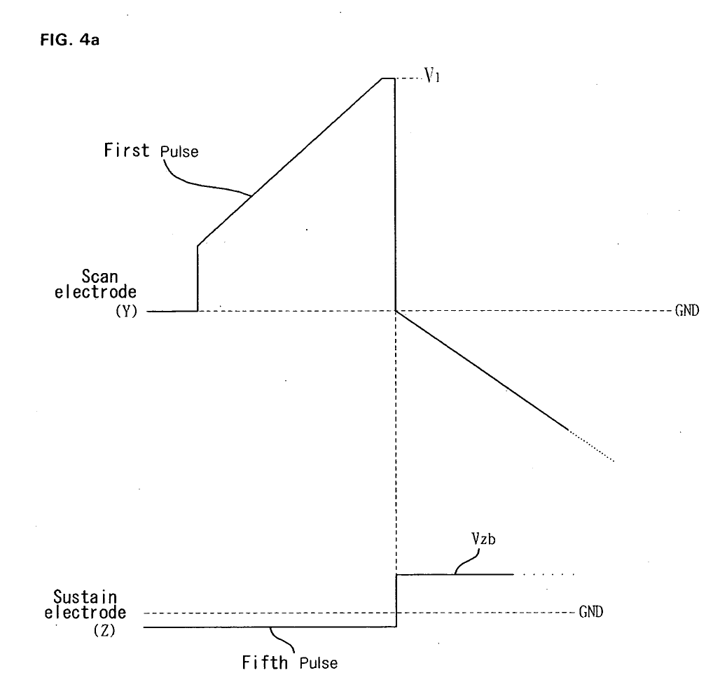

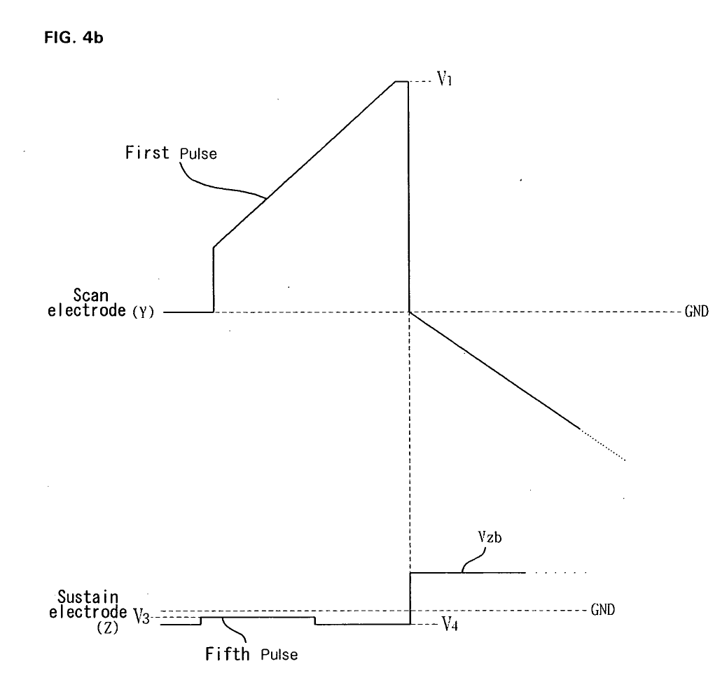

The fifth pulse is described in detail with reference to FIGS. 4a and 4b.

As illustrated in FIG. 4a, it is preferable that the fifth pulse applied to the sustain electrode Z during the application of the first pulse to the scan electrode Y has a negative voltage level.

When that the fifth pulse has a negative voltage level, the setup discharge may strongly occurs, though a voltage level of the first pulse applied to the scan electrode Y is relatively low.

As illustrated in FIG. 4b, it is preferable that the fifth pulse has a voltage varying with time. For example, the fifth pulse may have a third voltage level V3 and a fourth voltage level V4 during the application of the first pulse to the scan electrode Y.

Further, the fifth pulse, as illustrated in FIG. 3, may have a constant voltage.

Next, after applying the first pulse, a second pulse in which a voltage varies with time until reaching a second voltage level V2 is applied to the scan electrode Y during the reset period. The second pulse has a polarity opposite to a polarity of the first pulse. For example, the first pulse, which gradually falls from a given voltage (preferably, a ground level voltage) less than a peak voltage (i.e., the first voltage level V1) of the first pulse to the second voltage level V2 in the form of ramp-down is applied to the scan electrode Y during a set-down period of the reset period.

As a result, a weak erase discharge, i.e., a set-down discharge occurs within the discharge cell. The set-down discharge erase a portion of the wall charges accumulated within the discharge cell by the setup discharge. Accordingly, the remaining wall charges are uniform within the cells to the extent that the address discharge can be stably performed.

During an address period which follows the reset period including the setup period and the set-down period, a third pulse corresponding to a data pulse is applied to the address electrode X through a first circuit comprising an inductor.

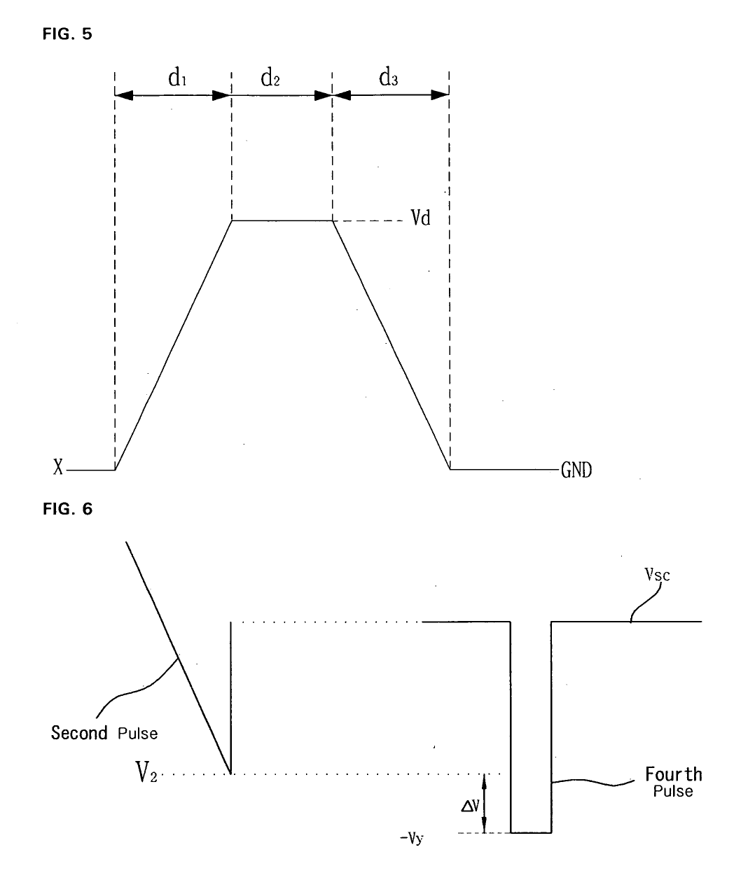

The third pulse is described in detail with reference to FIG. 5.

As illustrated in FIG. 5, the third pulse applied to the address electrode X during the address period comprises a rising period d1, a maintaining period d2 and a falling period d3.

During the rising period d1, the data pulse rises from a ground level voltage GND to a data voltage Vd. It is preferable that the rising period d1 ranges from about 75 ns to about 800 ns.

As described above, since the rising period d1 of the data pulse ranges from about 75 ns to about 800 ns, a coupling effect between the adjacent address electrodes X in the rising period d1 decreases such that a noise and electro magnetic interference decrease.

During the maintaining period d2, the data pulse is substantially maintained at the data voltage Vd.

During the falling period d3, the data pulse falls from the data voltage Vd to a ground level voltage GND.

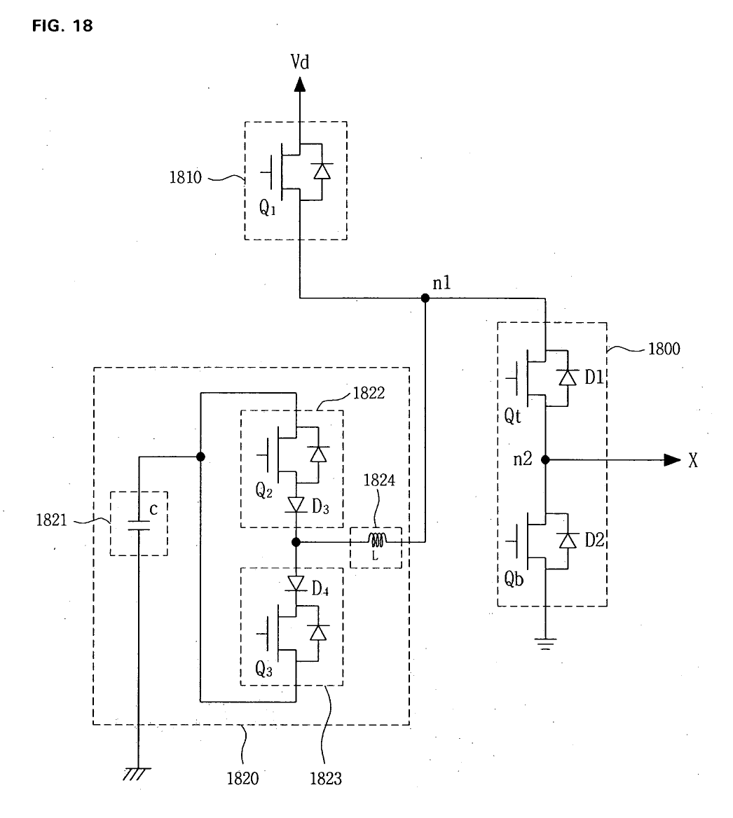

The first circuit comprising the inductor for generating the data pulse corresponding to the third pulse will be described in detail with reference to the drawings subsequent to FIG. 18.

A fourth pulse is applied to the scan electrode Y during the application of the third pulse to the address electrode X. For example, the fourth pulse falling from a scan reference voltage Vsc to a scan voltage −Vy of a negative polarity is applied to the scan electrode Y corresponding to the third pulse.

The fourth pulse is described in detail with reference to FIG. 6.

As illustrated in FIG. 6, the lowest voltage level, i.e., the scan voltage −Vy of the negative polarity of the fourth pulse is lower than the lowest voltage level, i.e., the second voltage level V2 of the second pulse.

A difference (ΔV) between the lowest voltage level of the fourth pulse and the lowest voltage level of the second pulse ranges from 5V to 50V.

A portion of the fourth pulse is overlapped with a portion of the second pulse.

As the voltage difference between the scan voltage −Vy of the negative polarity of the fourth pulse and the data voltage Vd of the third pulse is added to the wall voltage generated during the reset period, the address discharge is generated within the discharge cells to which the third pulse is applied.

Wall charges are formed within the discharge cells selected by performing the address discharge such that when a sustain voltage Vs of a sustain pulse is applied a discharge occurs.

A sustain bias voltage Vzb is applied to the sustain electrode Z during the set-down period and the address period so that an erroneous discharge does not occur between the sustain electrode Z and the scan electrode Y.

During a sustain period for light emission which follows the address period, a plurality of pulses are applied to the scan electrode Y through a second circuit comprising at least one inductor. For example, the plurality of pulses of the sustain pulse type having the sustain voltage Vs are applied to the scan electrode Y.

A plurality of pulses is applied to the sustain electrode Z through a third circuit comprising at least one inductor during the sustain period. For example, the plurality of pulses of the sustain pulse type having the sustain voltage Vs are applied to the sustain electrode Z.

It is preferable that at least one of the plurality of pulses applied to the sustain electrode Z during the sustain period is substantially synchronized with at least one of the plurality of pulses applied to the scan electrode Y during the sustain period.

As the wall voltage within the cells selected by performing the address discharge is added to the sustain voltage Vs of the plurality of pulses, every time the plurality of pulses are applied, a sustain discharge, i.e., a display discharge is generated in the cells selected during the address period. Accordingly, a given image is displayed on the plasma display panel.

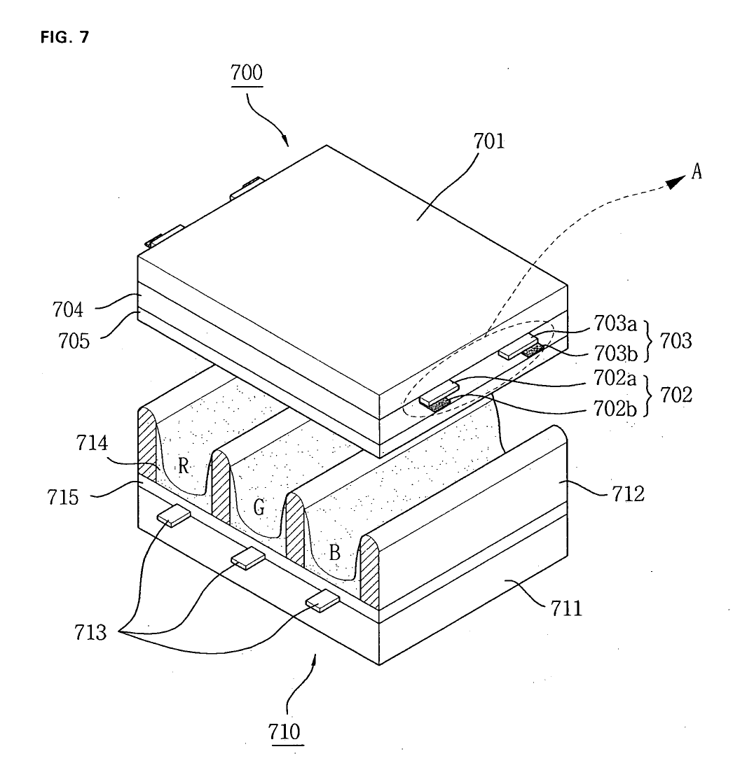

An example of the structure of the plasma display panel to which the driving method according to the embodiment of the present invention is applied will be described with reference to FIG. 7.

Referring to FIG. 7, the plasma display panel to which the driving method according to the embodiment of the present invention is applied comprises a front panel 700 and a rear panel 710 which are coalesced in parallel to each other at a given distance therebetween. The front panel 700 comprises a front substrate 701 on which a scan electrode 702 and a sustain electrode 703 are formed. The rear panel 710 comprises a rear substrate 711 on which an address electrode 713 is formed to intersect with the scan electrode 702 and the sustain electrode 703.

The scan electrode 702 and the sustain electrode 703 are formed in parallel to each other on the front substrate 701. The scan electrode 702 and the sustain electrode 703 generate a discharge within the discharge cell and maintain the discharge of the discharge cell.

The scan electrode 702 and the sustain electrode 703 each may be formed of a plurality of layers.

Light transmissivity and electrical conductivity of the scan electrode 702 and the sustain electrode 703 need to be considered to emit light generated within the discharge cell to the outside and to secure driving efficiency. Accordingly, it is preferable that the scan electrode 702 and the sustain electrode 703 each comprise transparent electrodes 702a and 703a made of transparent indium-tin-oxide (ITO) material and bus electrodes 702b and 703b made of opaque Ag.

Since the scan electrode 702 and the sustain electrode 703 each comprise the transparent electrodes 702a and 703a, visible light generated within the discharge cell is efficiently emitted to the outside of the plasma display panel.

Since the scan electrode 702 and the sustain electrode 703 each comprise the bus electrodes 702b and 703b, the bus electrodes 702b and 703b prevent a reduction in the driving efficiency caused by the transparent electrodes 702a and 703a with low electrical conductivity. In other words, the bus electrodes 702b and 703b compensate the low electrical conductivity of the transparent electrodes 702a and 703a.

An upper dielectric layer 704 is formed on the front substrate 701, on which the scan electrode 702 and the sustain electrode 703 are formed, to cover the scan electrode 702 and the sustain electrode 703.

The upper dielectric layer 704 limits a discharge current of the scan electrode 702 and the sustain electrode 703 and provides insulation between the scan electrode 702 and the sustain electrode 703. A Pb content of the upper dielectric layer 704 is equal to or less than 1,000 ppm.

A protective layer 705 is formed on an upper surface of the upper dielectric layer 704 to facilitate discharge conditions. The protective layer 705 is formed using a material such as MgO through a deposition method, and the like.

The address electrode 713 formed on the rear substrate 711 applies data to the discharge cell.

A lower dielectric layer 715 is formed on the rear substrate 711, on which the address electrode 713 is formed, to cover the address electrode 713. The lower dielectric layer 715 provides insulation between the address electrodes 713. A Pb content of the lower dielectric layer 715 is equal to or less than 1,000 ppm.

A stripe-type (or well-type) barrier rib 712 is formed on the lower dielectric layer 715 to partition a discharge space i.e., a discharge cell. Accordingly, Red (R), green (G) and blue (B) discharge cells are formed between the front substrate 701 and the rear substrate 711. A Pb content of the barrier rib 712 is equal to or less than 1,000 ppm.

The discharge cell formed by the barrier rib 712 is filled with a predetermined discharge gas.

A phosphor 714 for emitting visible light for an image display when the address discharge occurs is formed within the discharge cell partitioned by the barrier rib 712. For example, a red (R) phosphor, a green (G) phosphor and a blue (B) phosphor may be formed.

In the plasma display panel of the above-described structure, a driving voltage is applied to at least one of the scan electrode 702, the sustain electrode 703 or the address electrode 713, and then a discharge occurs within the discharge cell partitioned by the barrier rib 712.

The discharge gas filled in the discharge cell generates vacuum ultraviolet rays, and the vacuum ultraviolet rays excite the phosphor 714 formed inside the discharge cell. The excited phosphor 714 generates visible light. The visible light is emitted to the outside through the front substrate 701 on which the upper dielectric layer 704 is formed, thereby displaying an image on an external surface of the front substrate 701.

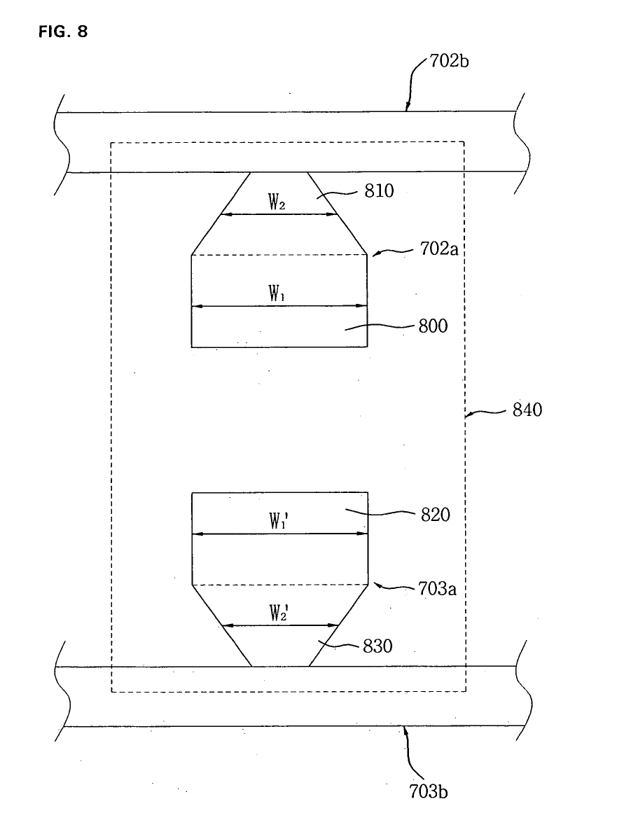

Next, the structure of each of the scan electrode and the sustain electrode will be described in detail with reference to FIG. 8.

As illustrated in FIG. 8, the scan electrode projects toward the middle potion of a discharge cell 840 within the discharge cell 840.

More specifically, the scan electrode 702 comprises the transparent electrode 702a and the bus electrodes 702b. The transparent electrode 702a is electrically connected to the bus electrodes 702b within the discharge cell 840. The transparent electrode 702a projects toward the middle portion of the discharge cell 840.

The transparent electrode 702a adjacent to the bus electrodes 702b comprises a first portion 810 and a second portion 800. The first portion 810 has a second width W2 which is an average width in a horizontal direction. The second portion 800 is formed to be successively connected with the first portion 810, and has a first width W1 which is an average width in a horizontal direction.

The first width W1 of the second portion 800 is more than the second width W2 of the first portion 810.

The second width W2 of the first portion 810 gradually widens toward the middle portion of the discharge cell 800, and the first width W1 of the second portion 800 is substantially uniform.

It is preferable that the transparent electrode 703a of the sustain electrode 703 is electrically connected to the bus electrodes 703b within the discharge cell 840, and the transparent electrode 702a projects toward the middle portion of the discharge cell 840.

The transparent electrode 703a adjacent to the bus electrodes 703b comprises a third portion 830 and a fourth portion 820. The third portion 830 has a second width W2′ which is an average width in a horizontal direction. The fourth portion 820 is formed to be successively connected with the third portion 830, and has a first width W1′ which is an average width in a horizontal direction.

The first width W1′ of the fourth portion 820 is more than the second width W2′ of the third portion 830.

The second width W2′ of the third portion 830 gradually widens toward the discharge cell 840, and the first width W1′ of the fourth portion 820 is substantially uniform.

As described above, the width of the scan electrode 702 widens toward the middle portion of the discharge cell 840 such that an opposing region between the scan electrode 702 and the sustain electrode 703 within the discharge cell 840 increases, thereby improving efficiency of a discharge generated between the scan electrode 702 and the sustain electrode 703.

In particular, as illustrated in FIG. 8, when the width of the scan electrode 702 widens toward the middle portion of the discharge cell 840 and the width of the sustain electrode 703 widens toward the middle portion of the discharge cell 840, efficiency of a discharge generated between the scan electrode 702 and the sustain electrode 703 further increases.

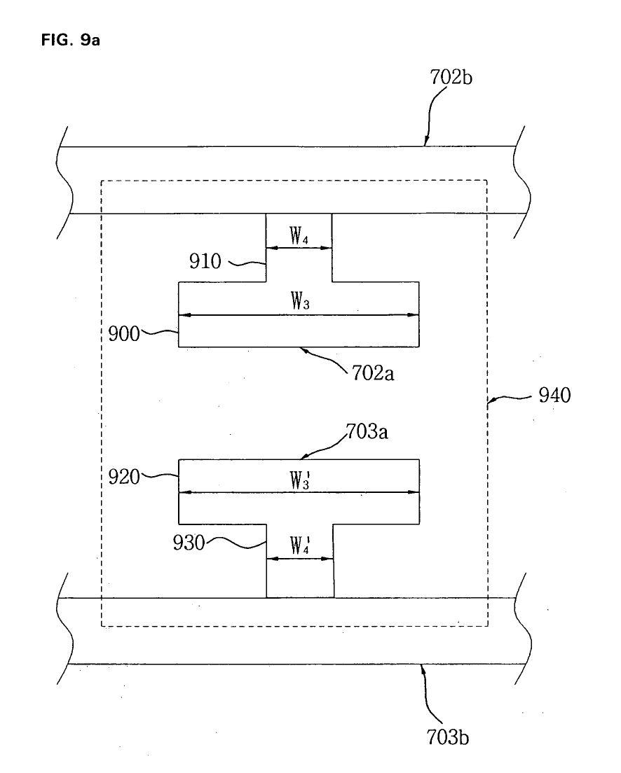

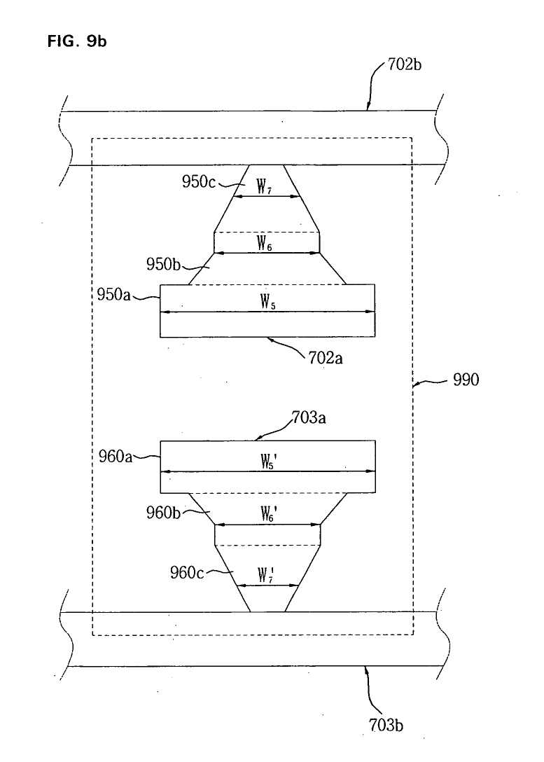

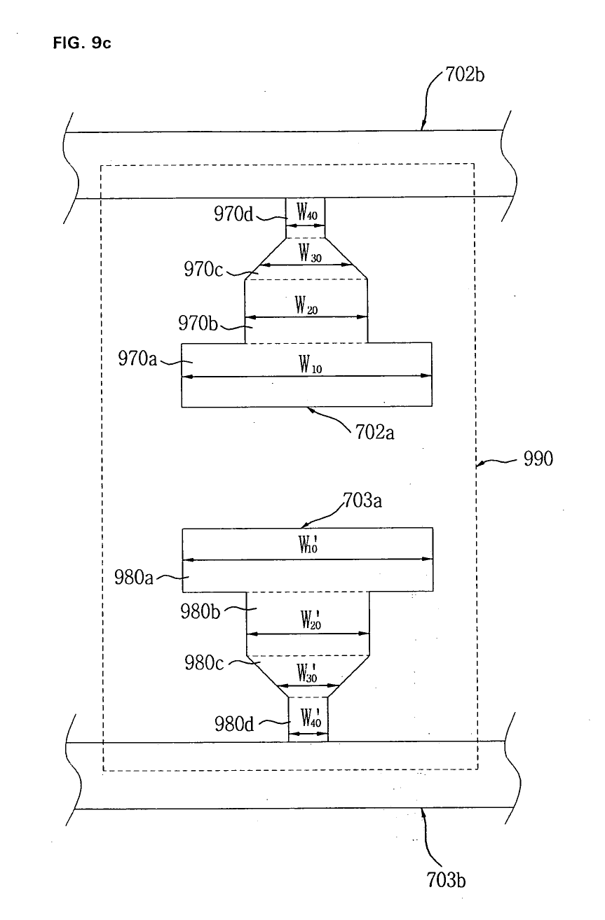

FIGS. 9a to 9c illustrate another structure of each of the scan electrode and the sustain electrode.

As illustrated in FIG. 9a, the transparent electrode 702a of the scan electrode 702 is adjacent to the bus electrodes 702b, and comprises a first portion 910 and a second portion 900. The first portion 910 has a fourth width W4 which is the width in a horizontal direction. The second portion 900 is formed to be successively connected with the first portion 910, and has a third width W3 which is the width in a horizontal direction.

The third width W3 of the second portion 900 is more than the fourth width W4 of the first portion 910.

The fourth width W4 of the first portion 910 and the third width W3 of the second portion 900 are substantially uniform.

Further, the transparent electrode 703a of the sustain electrode 703 is adjacent to the bus electrodes 703b, and comprises a third portion 930 and a fourth portion 920. The third portion 930 has a fourth width W4′ which is the width in a horizontal direction. The fourth portion 920 is formed to be successively connected with the third portion 930, and has a third width W3′ which is the width in a horizontal direction.

The third width W3′ of the fourth portion 920 is more than the fourth width W4′ of the third portion 930.

The fourth width W4′ of the third portion 930 and the third width W3′ of the fourth portion 920 are substantially uniform.

As described above, the scan electrode 702 may be formed in a T shape. Further, the scan electrode 702 and the sustain electrode 703 may be formed in a T shape.

As illustrated in FIG. 9b, the scan electrode 702 comprises a first portion 950c with a seventh width W7, a second portion 950b with a sixth width W6 more than the seventh width W7, and a third portion 950a with a fifth width W5 more than the sixth width W6.

More specifically, the transparent electrode 702a of the scan electrode 702 is adjacent to the bus electrode 702b. The transparent electrode 702a comprises the first portion 950c with the seventh width W7 which is an average width in a horizontal direction, the second portion 950b with the sixth width W6 more than the seventh width W7, and the third portion 950a with the fifth width W5 which is the width in a horizontal direction and is more than the sixth width W6. The third portion 950a is formed to be successively connected with the second portion 950b.

It is preferable that the width of at least one of the first portion 950c and the second portion 950b widens toward the middle portion of a discharge cell 990. Further, the fifth width W5 of the third portion 950a is substantially uniform.

For example, the seventh width W7 of the first portion 950c gradually widens toward the middle portion of the discharge cell 990. The sixth width W6 of the second portion 950b is uniform up to a predetermined portion of the second portion 950b, and then gradually widens toward the middle portion of the discharge cell 990. The fifth width W5 of the third portion 950a is substantially uniform.

The sustain electrode 703 comprises a fourth portion 960c with a seventh width W7′, a fifth portion 960b with a sixth width W6′ more than the seventh width W7′, and a sixth portion 960a with a fifth width W5′ more than the sixth width W6′.

More specifically, the transparent electrode 703a of the sustain electrode 703 is adjacent to the bus electrode 7032b. The transparent electrode 703a comprises the fourth portion 960c with the seventh width W7′ which is an average width in a horizontal direction, the fifth portion 960b with the sixth width W6′ more than the seventh width W7′, and the sixth portion 960a with the fifth width W5′ which is the width in a horizontal direction and is more than the sixth width W6. The sixth portion 960a is formed to be successively connected with the fifth portion 960b.

It is preferable that the width of at least one of the fourth portion 960c and the fifth portion 960b widens toward the middle portion of the discharge cell 990. Further, the fifth width W5′ of the sixth portion 960a is substantially uniform.

For example, the seventh width W7′ of the fourth portion 960c gradually widens toward the middle portion of the discharge cell 990. The sixth width W6′ of the fifth portion 960b is uniform up to a predetermined portion of the fifth portion 960b, and then gradually widens toward the middle portion of the discharge cell 990. The fifth width W5′ of the sixth portion 960a is substantially uniform.

As illustrated in FIG. 9c, the scan electrode 702 comprises a first portion 970d with a fortieth width W40, a second portion 970c with a thirtieth width W30 more than the fortieth width W40, a third portion 970b with a twentieth width W20 more than the thirtieth width W30, and a fourth portion 970a with a tenth width W10 more than the twentieth width W20.

More specifically, the transparent electrode 702a of the scan electrode 702 is adjacent to the bus electrode 702b. The transparent electrode 702a comprises the first portion 970d with the fortieth width W40 which is an average width in a horizontal direction, the second portion 970c with the thirtieth width W30 which is an average width in a horizontal direction and is more than the fortieth width W40, the third portion 970b with the twentieth width W20 which is an average width in a horizontal direction and is more than the thirtieth width W30, and the fourth portion 970a with the tenth width W10 which is an average width in a horizontal direction and is more than the twentieth width W20. The second portion 970c is formed to be successively connected with the first portion 970d. The third portion 970b is formed to be successively connected with the second portion 970c. The fourth portion 970a is formed to be successively connected with the third portion 970b.

It is preferable that the width of at least one of the first portion 970d, the second portion 970c or the third portion 970b widens toward the middle portion of the discharge cell 990, and the width of the fourth portion 970a is substantially uniform.

For example, the width of the first portion 970d is substantially maintained at the fortieth width W40. The width of the second portion 970c widens toward the middle portion of the discharge cell 990. The width of the third portion 970b is substantially maintained at the twentieth width W20. The width of the fourth portion 970a is substantially maintained at the tenth width W10.

Further, similar to the scan electrode 702, the sustain electrode 703 comprises a fifth portion 980d with a fortieth width W40′, a sixth portion 980c with a thirtieth width W30′ more than the fortieth width W40′, a seventh portion 980b with a twentieth width W20′ more than the thirtieth width W30′, and an eighth portion 980a with a tenth width W10′ more than the twentieth width W20′.

More specifically, the transparent electrode 703a of the sustain electrode 703 is adjacent to the bus electrode 703b. The transparent electrode 703a comprises the fifth portion 980d with the fortieth width W40′ which is an average width in a horizontal direction, the sixth portion 980c with the thirtieth width W30′ which is an average width in a horizontal direction and is more than the fortieth width W40′, the seventh portion 980b with the twentieth width W20′ which is an average width in a horizontal direction and is more than the thirtieth width W30′, and the eighth portion 980a with the tenth width W10′ which is an average width in a horizontal direction and is more than the twentieth width W20′. The sixth portion 980c is formed to be successively connected with the fifth portion 980d. The seventh portion 980b is formed to be successively connected with the sixth portion 980c. The eighth portion 980a is formed to be successively connected with the seventh portion 980b.

It is preferable that the width of at least one of the fifth portion 980d, the sixth portion 980c or the seventh portion 980b widens toward the middle portion of the discharge cell 990, and the width of the eighth portion 980a is substantially uniform.

For example, the width of the fifth portion 980d is substantially maintained at the fortieth width W40′. The width of the sixth portion 980c widens toward the middle portion of the discharge cell 990. The width of the seventh portion 980b is substantially maintained at the twentieth width W20′. The width of the eighth portion 980a is substantially maintained at the tenth width W10′.

As described above, the scan electrode 702 and the sustain electrode 703 may be formed in various forms.

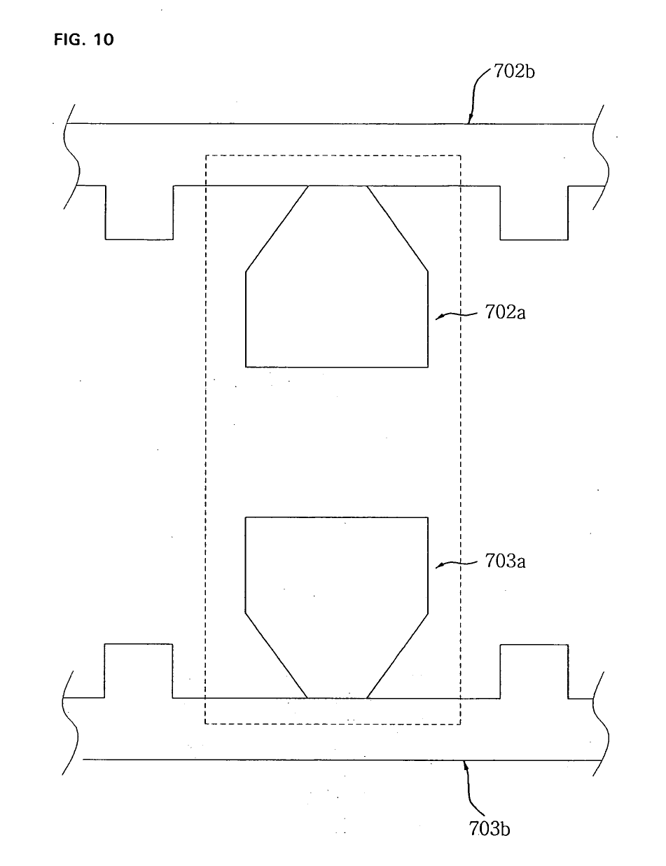

FIG. 10 illustrates a bus electrode.

As illustrated in FIG. 10, the scan electrode 702 and the sustain electrode 703 each comprise the transparent electrodes 702a and 703a and the bus electrodes 702b and 703b.

The bus electrodes 702b and 703b has a predetermined pattern. For example, the bus electrodes 702b and 703b has a pattern shaped by a projecting portion projecting in an opposing direction of the scan electrode 702 and the sustain electrode 703.

The bus electrodes 702b and 703b may be formed in various patterns depending on conditions such as the size of the discharge cell, the composition of the discharge gas within the discharge cell.

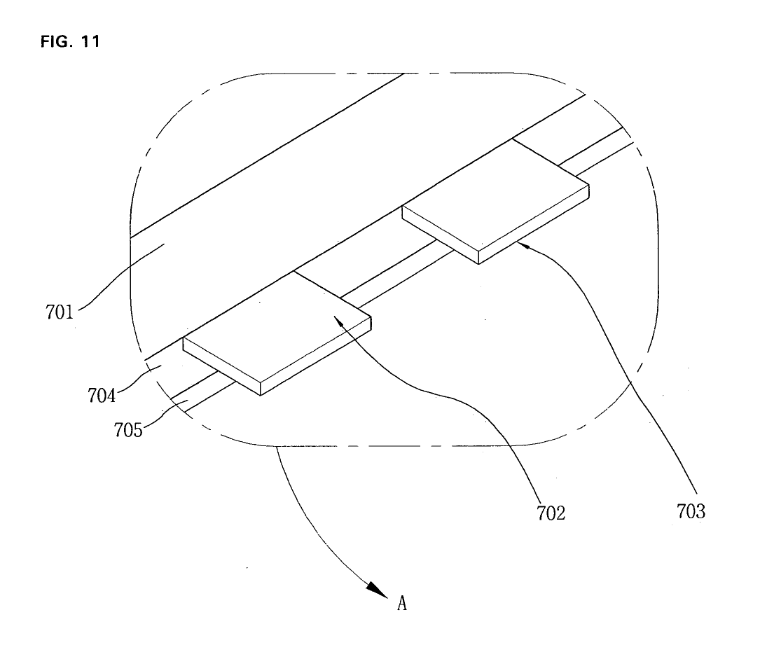

FIG. 11 illustrates the scan electrode or the sustain electrode comprising a bus electrode.

As illustrated in FIG. 11, unlike FIG. 7, the scan electrode 702 and the sustain electrode 703 each are formed in the form of a single layer. It is preferable that the scan electrode 702 and the sustain electrode 703 are made of an opaque metal material with the electrical conductivity.

More specifically, in FIG. 7, the scan electrode 702 and the sustain electrode 703 each comprise the transparent electrodes 702a and 703a and the bus electrodes 702b and 703b. However, in FIG. 11, the scan electrode 702 and the sustain electrode 703 each comprise only the bus electrodes 702b and 703b.

As described above, when the scan electrode 702 or the sustain electrode 703 comprises only the bus electrode, the electrical conductivity of the scan electrode 702 or the sustain electrode 703 is improved such that the driving efficiency further increases.

When the scan electrode 702 or the sustain electrode 703 comprises only the bus electrode, it is preferable that a black layer is formed to prevent the generation of reflection light caused by the bus electrode.

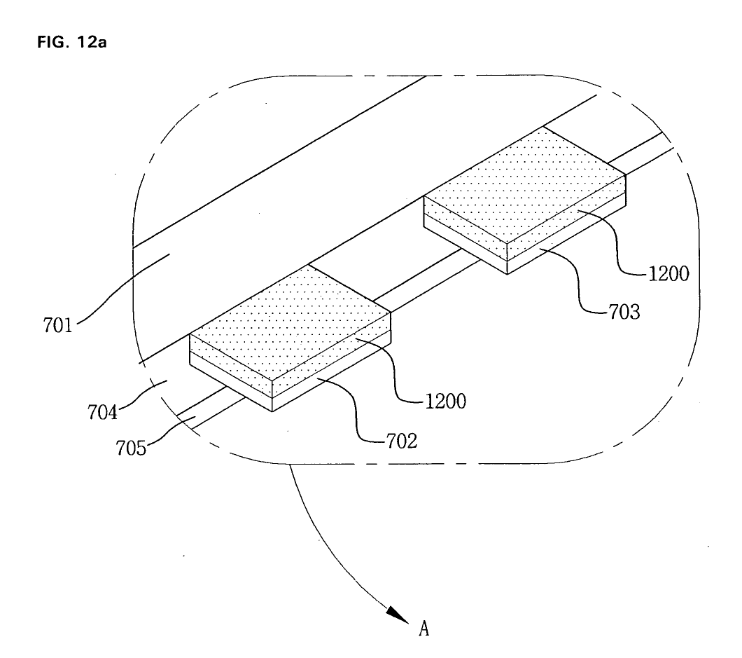

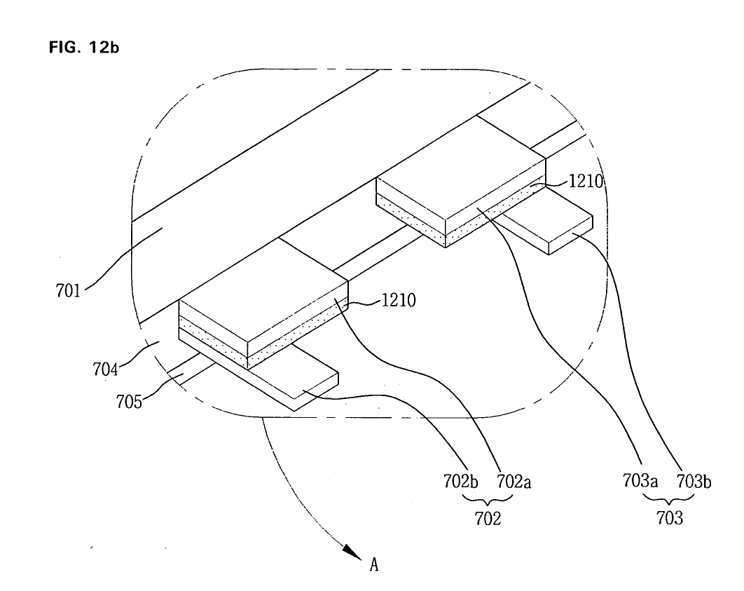

FIGS. 12a and 12b illustrate the structure of a black layer for preventing the generation of reflection light caused by the bus electrode.

As illustrated in FIG. 12a, when the scan electrode 702 or the sustain electrode 703 comprises only the bus electrode as illustrated in FIG. 11, the bus electrode is made of a metal material of the electrical conductivity such as Ag, thereby causing the glare on eyes of a viewer by the reflection of incident light from the outside on the scan electrode 702 or the sustain electrode 703.

To prevent the glare caused by the reflection of the incident light, a black layer 1200 is formed between the front substrate 701 and the scan electrode 702 or the sustain electrode 703. The black layer 1200 is overlapped with a portion of the scan electrode 702 or the sustain electrode 703.

As illustrated in FIG. 12b, when the scan electrode 702 or the sustain electrode 703 comprises the transparent electrode 702a or 703a and the bus electrode 702b or 703b as illustrated in FIG. 7, a black layer 1210 is formed between the transparent electrode 702a or 703a and the bus electrode 702b or 703b.

The black layer 1210 prevents the reflection of incident light from the outside caused by the bus electrode 702b or 703b.

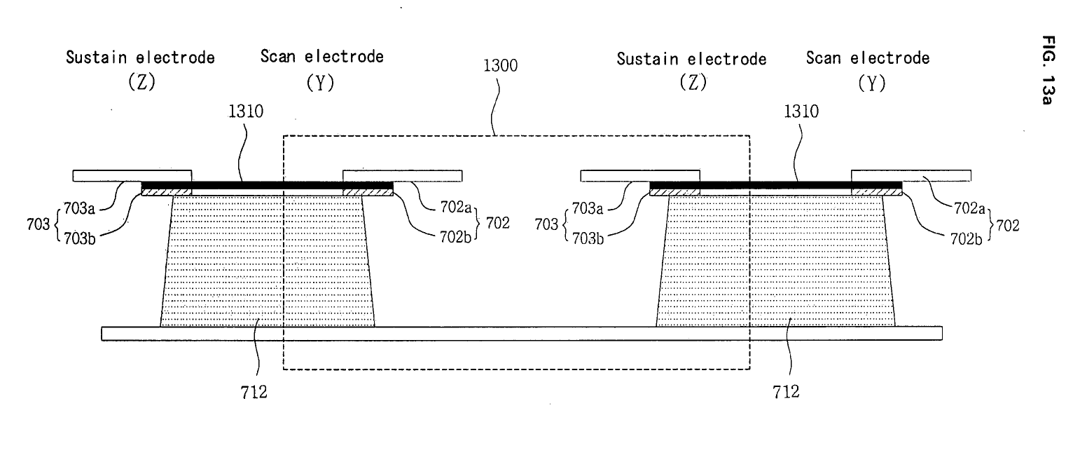

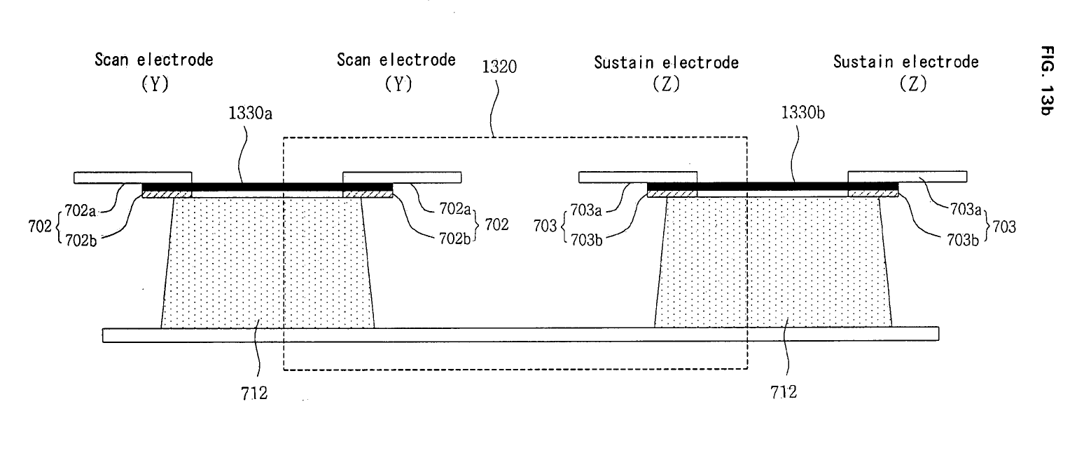

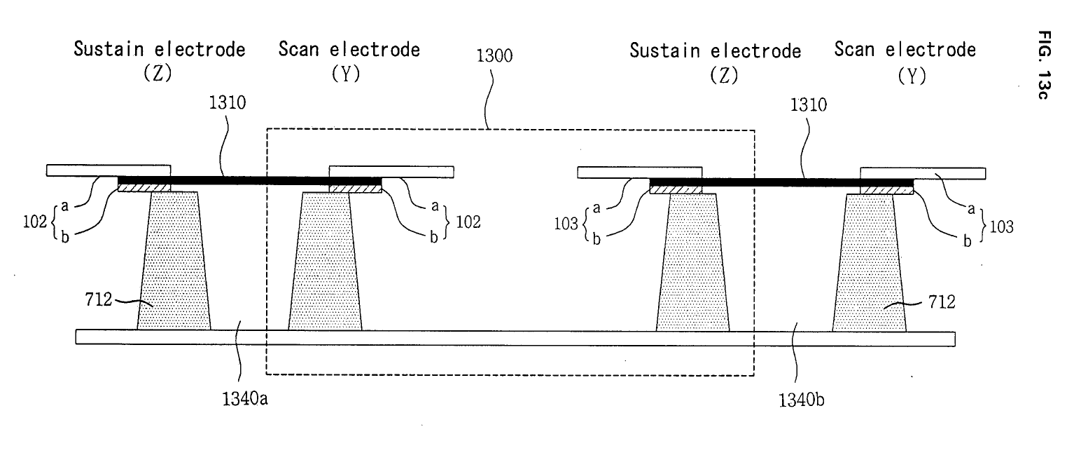

FIGS. 13a to 13c illustrate another structure of the black layer.

As illustrated in FIG. 13a, the scan electrode 702 or the sustain electrode 703 is formed within a discharge cell 1300. The barrier rib 712 for partitioning the discharge cells is located between the discharge cell 1300 and a discharge cell adjacent to the discharge cell 1300.

The barrier rib 712 is generally made of glass, thereby reflecting incident light from the outside.

To prevent the generation of the reflection light caused by the barrier rib 712, a black layer 1310 is formed at a location corresponding to an upper part of the barrier rib 712 for partitioning the adjacent discharge cell.

Preferably, the black layer 1310 is formed between the scan electrode 702 and the sustain electrode 703 to correspond to the upper part of the barrier rib 712 for partitioning the discharge cell 1300 between the front substrate and the rear substrate.

More preferably, the black layer formed between the transparent electrode 702a and the bus electrode 702b of the scan electrode 702 and the black layer formed between the transparent electrode 703a and the bus electrode 703b of the sustain electrode 703 are integrated into one black layer 1310. The integrated black layer 1310 can cover the bus electrode 702b of the scan electrode 702, the bus electrode 703b of the sustain electrode 703 and the barrier rib 712. Accordingly, the number of manufacturing processes of the black layer 1310 and the manufacturing time and the manufacturing cost of the black layer 1310 are reduced.

In FIG. 13a, the electrodes are arranged in order of the scan electrode 702, the sustain electrode 703, the scan electrode 702 and the sustain electrode 703.

In FIG. 13b, the electrodes are arranged in order of the scan electrode 702, the scan electrode 702, the sustain electrode 703 and the sustain electrode 703.

In FIG. 13b, to integrate the black layers into one black layer as illustrated in FIG. 13a, black layers 1330a and 1330b are formed between the scan electrode 702 and the scan electrode 702 and between the sustain electrode 703 and the sustain electrode 703 to correspond to the upper part of the barrier rib 712 for partitioning a discharge cell 1320 between the front substrate and the rear substrate.

In FIG. 13c, channels 1340a and 1340b are formed between the barrier ribs 712 to reduce capacitance of the whole of the plasma display panel.

In FIG. 13c, when a black layer 1310 is formed between the scan electrode 702 and the sustain electrode 703 to correspond to the upper part of the barrier rib 712, as illustrated in FIG. 13a, the black layer 1310 can cover the channels 1340a and 1340b as well as the bus electrode 702b of the scan electrode 702, the bus electrode 703b of the sustain electrode 703 and the barrier rib 712.

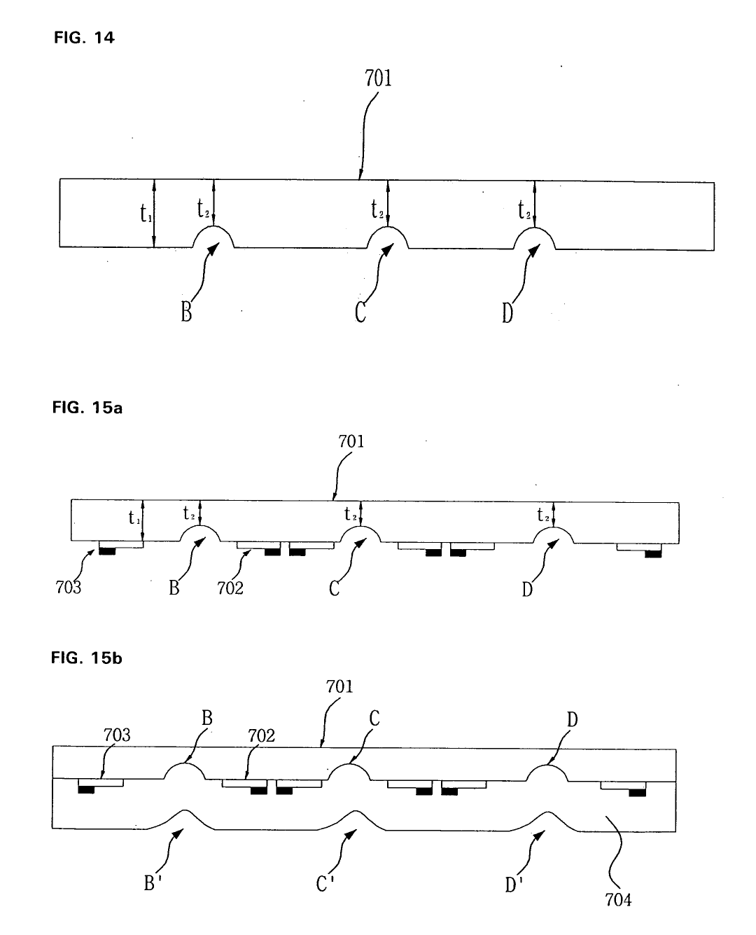

FIG. 14 illustrates a front substrate of the plasma display panel to which the driving method according to the embodiment of the present invention is applied.

As illustrated in FIG. 14, an inner surface of the front substrate 701 includes portions B, C and D with a different thickness.

For example, the portions B, C and D of the front substrate 701 each has a thickness of t2, and the thickness of the front substrate 701 except the portions B, C and D is t1. As described above, since the front substrate 701 with the different thicknesses are formed, the upper dielectric layer, the protective layer, and the like, formed on the front substrate 701 may have the different thicknesses such that the upper dielectric layer with the different thickness, the protective layer with the different thickness, and the like, can be manufactured easily.

FIGS. 15a and 15b illustrate a method of manufacturing the plasma display panel using the front substrate with the different thickness.

As illustrated in FIG. 15a, the scan electrode 702 and the sustain electrode 703 are formed on the inner surface of the front substrate 701 with the different thicknesses.

Preferably, the scan electrode 702 and the sustain electrode 703 are formed at both sides of each of the relatively thin portions B, C and D of the front substrate 701 with the thickness of t2.

As illustrated in FIG. 15b, the upper dielectric layer 704 is formed on the upper part of the front substrate 701 on which the scan electrode 702 and the sustain electrode 703 are formed.

A depressed portion with a predetermined depression depth is formed in portions B′, C′ and D′ of the upper dielectric layer 704 corresponding to the portions B, C and D of the front substrate 701.

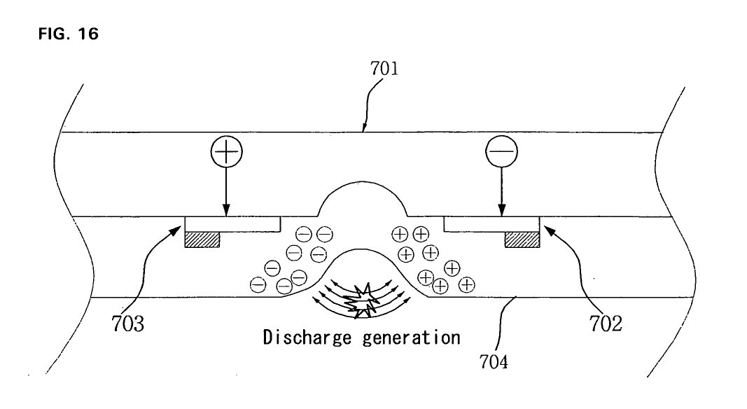

The depressed portion improves the discharge efficiency between the scan electrode 702 and the sustain electrode 703. The depressed portion will be described in detail with reference to FIG. 16.

As illustrated in FIG. 16, when a negative driving voltage is applied to the scan electrode 702 and a positive driving voltage is applied to the sustain electrode 703, a polarization is generated in a portion of the upper dielectric layer 704 corresponding to the scan electrode 702 so that the portion of the upper dielectric layer 704 corresponding to the scan electrode 702 has a positive voltage against the negative driving voltage applied to the scan electrode 702. The accumulation of positive charges on the portion of the upper dielectric layer 704 will be described as a substitute for the generation of the polarization in the portion of the upper dielectric layer 704, for the convenience of the explanation.

Further, a polarization is generated in a portion of the upper dielectric layer 704 corresponding to the sustain electrode 703 so that the portion of the upper dielectric layer 704 corresponding to the sustain electrode 703 has a negative voltage against the positive driving voltage applied to the sustain electrode 703. The accumulation of negative charges on the portion of the upper dielectric layer 704 will be described as a substitute for the generation of the polarization in the portion of the upper dielectric layer 704, for the convenience of the explanation.

When the depressed portion with the predetermined depression depth is formed in the upper dielectric layer 704, relatively much positive charges and relatively much negative charges are accumulated around the depressed portion.

Accordingly, a discharge is more easily generated between the scan electrode 702 and the sustain electrode 703. In other words, the depressed portion formed in the upper dielectric layer 704 improves efficiency of the discharge generated between the scan electrode 702 and the sustain electrode 703.

It is preferable that a film-type filter is formed on an external surface of the front substrate of the plasma display panel to which the driving method according to the embodiment of the present invention is applied.

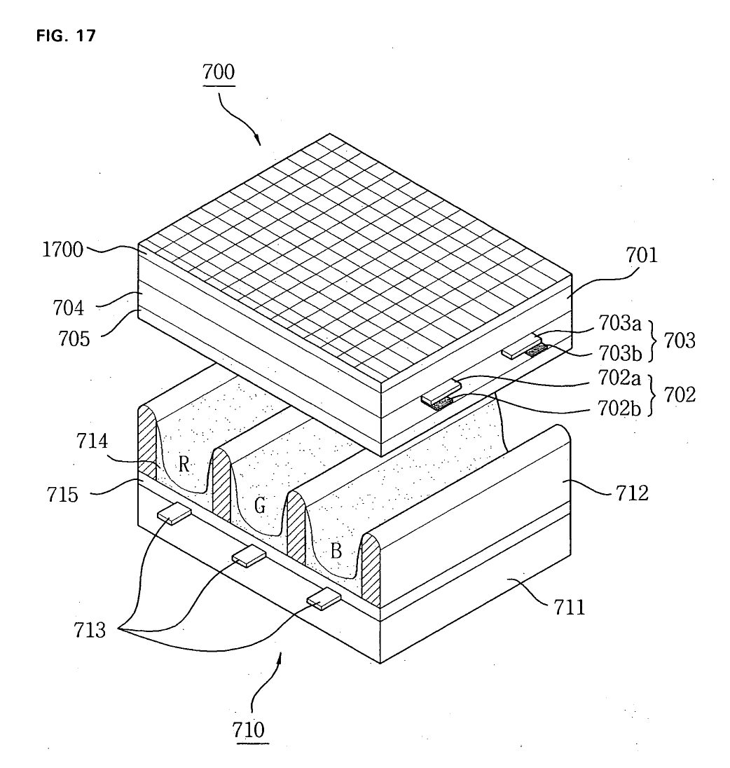

FIG. 17 illustrates a case where a film-type filter is formed on the front substrate of the plasma display panel to which the driving method according to the embodiment of the present invention is applied.

As illustrated in FIG. 17, a film-type filter 1700 is formed on an external surface of the front substrate 701 of the plasma display panel. In other words, an image filter of form equal to the form of the film-type filter 1700 is formed on the external surface of the front substrate 701.

Although it is not illustrated in the drawings, it is preferable that the film-type filter 1700 includes various function layers such as an electromagnetic interference shielding layer for reducing electro magnetic interference (EMI) caused by driving the plasma display panel, a near-infrared ray blocking layer for preventing malfunction caused by near-infrared ray, a color correction layer.

As previously described in FIG. 3, the third pulse corresponding to the data pulse is applied to the address electrode through a circuit comprising an inductor during the address period subsequent to the reset period including the setup period and the set-down period. It is preferable that the circuit comprising the inductor has an energy recovery function.

The configuration of the circuit comprising the inductor having the energy recovery function will be described with reference to FIG. 18.

As illustrated in FIG. 18, the circuit comprising the inductor having the energy recovery function comprises a data drive integrated circuit (IC) 1800, a data voltage application control unit 1810 and an energy recovery circuit 1820.

The data voltage application control unit 1810 comprises a data voltage application control switch Q1. The data voltage Vd applied from a data voltage source (not shown) is applied to the data drive IC 1800 through switching operations of the data voltage application control switch Q1.

The data drive IC 1800 is connected to the address electrode X of the plasma display panel. The data drive IC 1800 applies the voltage applied to the data drive IC 1800 to the address electrode X through predeterminate switching operations.

It is preferable that the data drive IC 1800 is formed in the form of a single module independent of the data voltage application control unit 1810 and the energy recovery circuit 1820. For example, it is preferable that the data drive IC 1800 is formed in the form of one chip on a tape carrier package (TCP).

It is preferable that the data drive IC 1800 comprises a top switch Qt and a bottom switch Qb.

One terminal of the top switch Qt is commonly connected to the data voltage application control unit 1810 and the energy recovery circuit 1820, and the other terminal is connected to one terminal of the bottom switch Qb.

The other terminal of the bottom switch Qb is grounded, and between the other terminal of the top switch Qt and one terminal of the bottom switch Qb, i.e., a second node n2 is connected to the address electrode X.

The energy recovery circuit 1820 comprises an energy storing unit 1821, an energy application control unit 1822, an energy recovery control unit 1823 and an inductor 1824.

The energy storing unit 1821 comprises an energy storing capacitor C. The energy storing capacitor C stores an energy which will be applied to the address electrode X of the plasma display panel, and stores an energy which will be recovered from the address electrode X of the plasma display panel.

The energy application control unit 1822 comprises an energy application control switch Q2. The energy application control switch Q2 forms an application path of the energy applied to the address electrode X of the plasma display panel from the energy storing capacitor C.

One terminal of the energy application control unit 1822 is connected to the energy storing capacitor C.

It is preferable that the energy application control unit 1822 further comprises a reverse blocking diode D3 for preventing an inverse current from flowing in the energy storing unit 1821 through the energy application control switch Q2.

The energy recovery control unit 1823 comprises an energy recovery control switch Q3. The energy recovery control switch Q3 forms a recovery path of the energy recovered from the address electrode X of the plasma display panel to the energy storing capacitor C.

One terminal of the energy recovery control unit 1823 is commonly connected to the energy storing capacitor C and the energy application control unit 1822.

It is preferable that the energy recovery control unit 1823 further comprises a reverse blocking diode D4 for preventing an inverse current from flowing from the energy storing unit 1821 to the energy recovery control switch Q3.

The inductor 1824 comprises a resonance inductor L. The energy stored in the energy storing unit 1821 is applied to the address electrode X of the plasma display panel through LC resonance using the resonance inductor L. Further, a reactive energy recovered from the plasma display panel is applied to the energy storing unit 1821 through LC resonance.

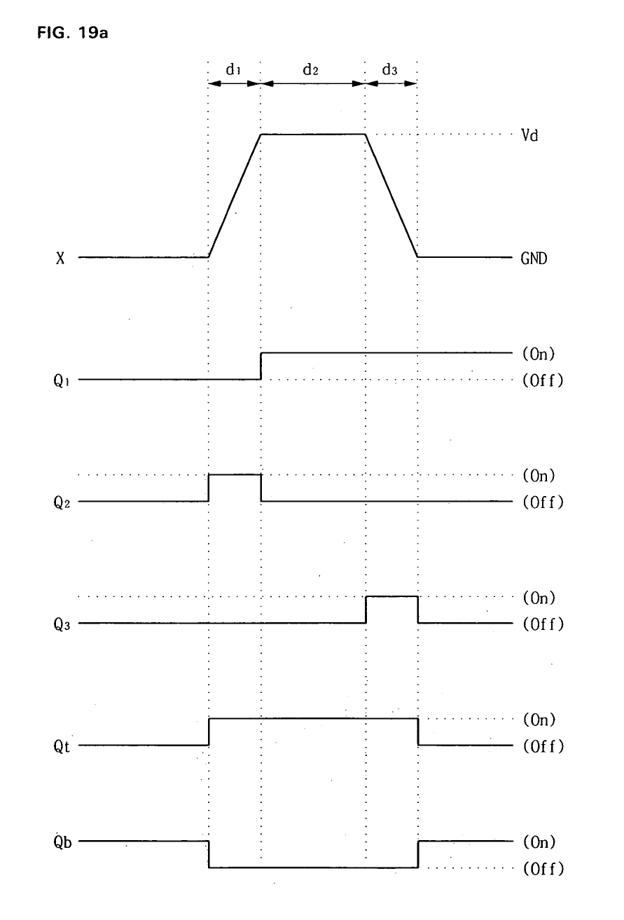

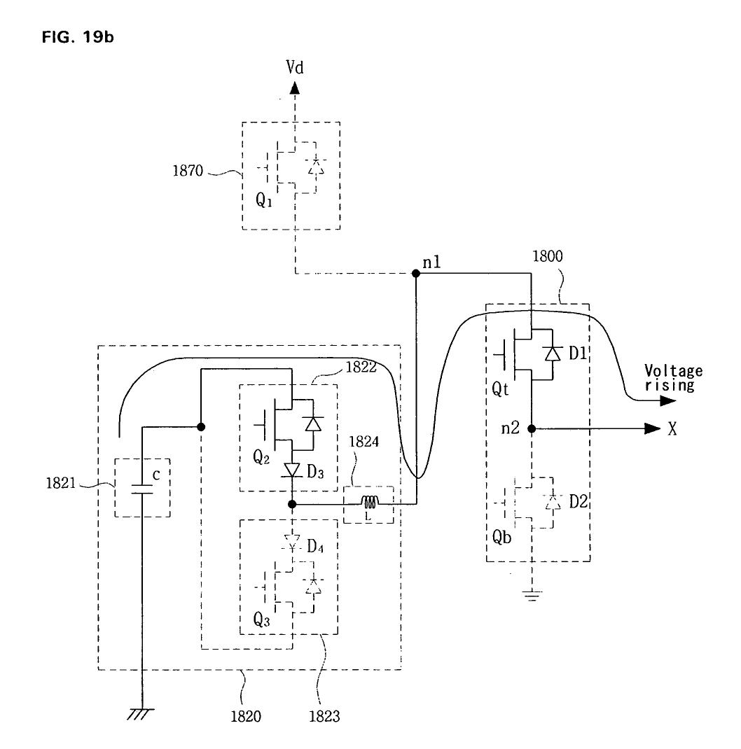

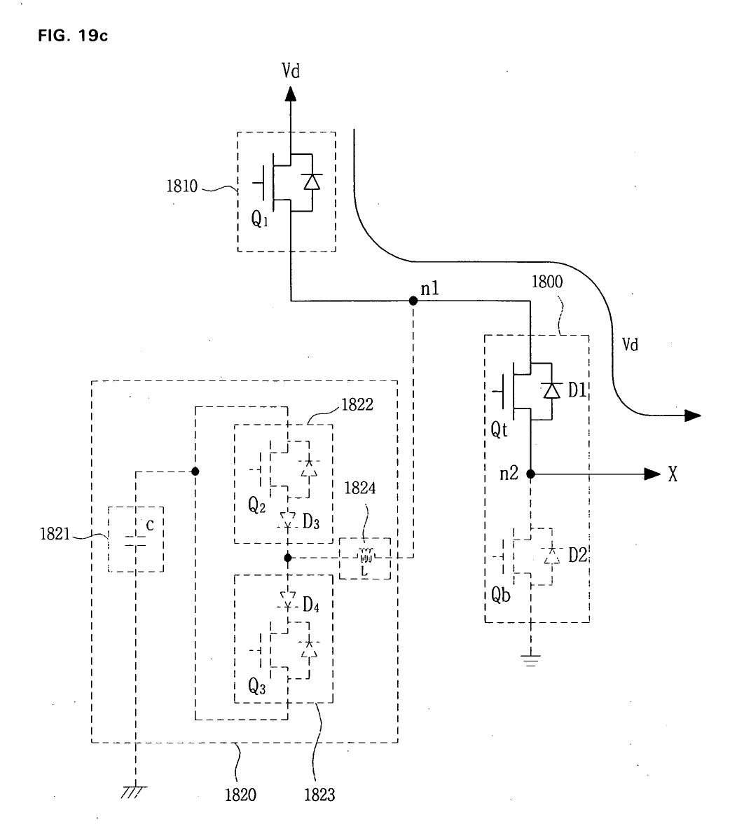

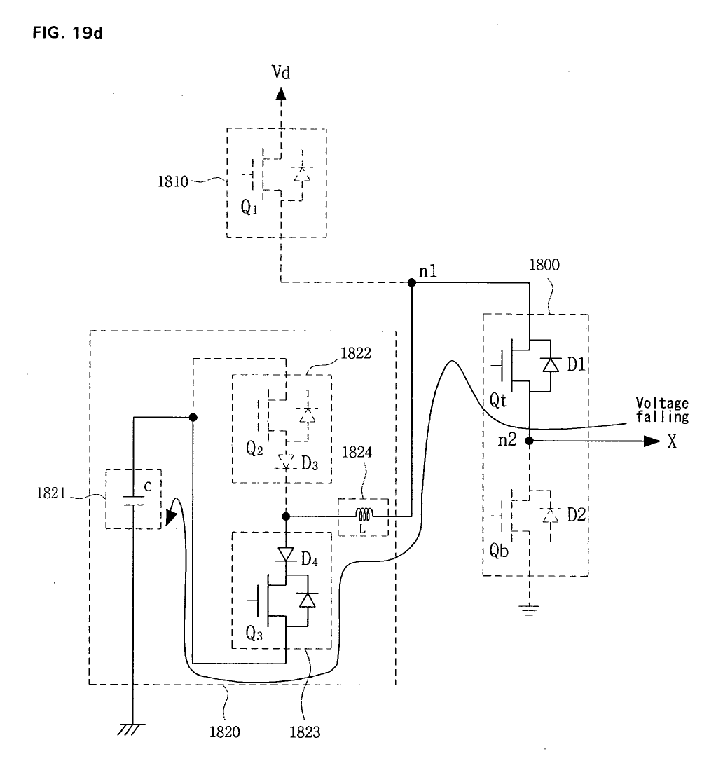

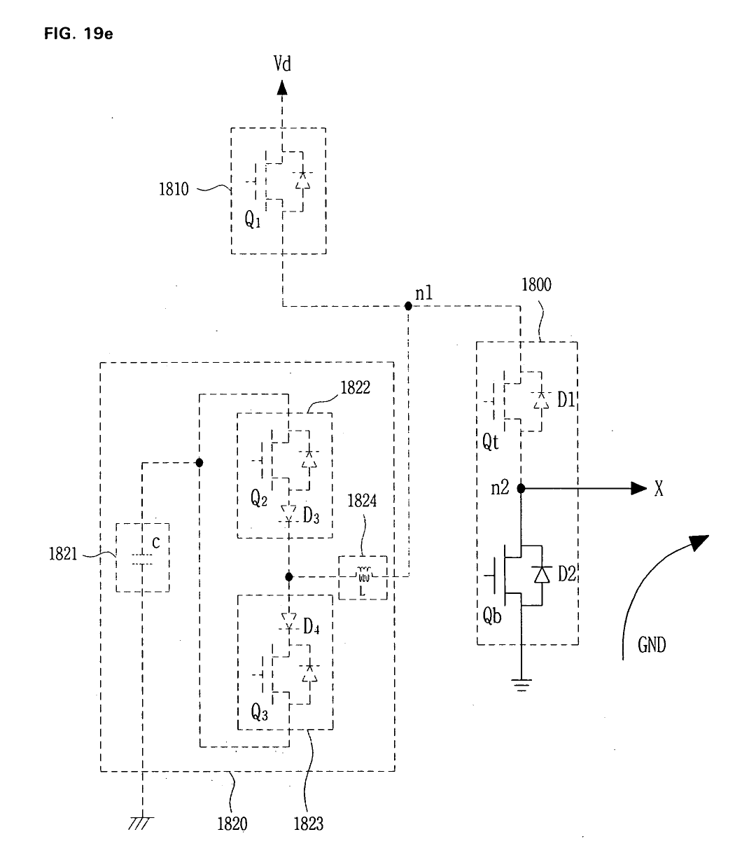

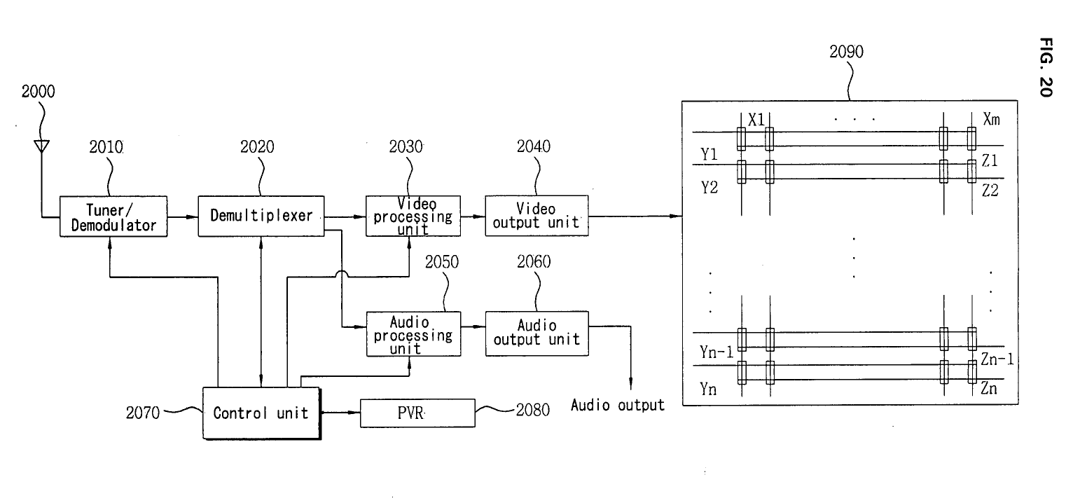

An operation of the circuit illustrated in FIG. 18 will be described in detail with reference to FIGS. 19a to 19e.

FIGS. 19a to 19e illustrate an operation of the circuit comprising the inductor of FIG. 18.

FIG. 19a is a switching timing diagram of the circuit of FIG. 18 for applying the third pulse having the rising period, the maintaining period and the falling period to the address electrode X.

During the rising period d1, the energy application control switch Q2 of the energy application control unit 1822 of the energy recovery circuit 1820 and the top switch Qt of the data drive IC 1800 are turned on.

Further, during the rising period d1, the energy recovery control switch Q3 of the energy recovery control unit 1823 of the energy recovery circuit 1820, the data voltage application control switch Q1 of the data voltage application control unit 1810, and the bottom switch Qb of the data drive IC 1800 are turned off.

As a result, as illustrated in FIG. 19b, the energy stored in the energy storing capacitor C of the energy storing unit 1821 is applied to the address electrode X of the plasma display panel through the energy application control unit 1822, the inductor 1824 and the top switch Qt of the data drive IC 1800.

A voltage of the energy applied to the address electrode X of the plasma display panel gradually rises with a predetermined slope by the LC resonance of the inductor 1824 during the rising period d1. In other words, a voltage of the third pulse gradually rises from a ground level voltage to the data voltage Vd.

During the maintaining period d2 subsequent to the rising period d1, the data voltage Vd is applied to the address electrode X.

During the maintaining period d2, the data voltage application control switch Q1 of the data voltage application control unit 1810 and the top switch Qt of the data drive IC 1800 are turned on. Further, the energy application control switch Q2 and the energy recovery control switch Q3 of the energy recovery circuit 1820 and the bottom switch Qb of the data drive IC 1800 are turned off.

As a result, as illustrated in FIG. 19c, the data voltage Vd is applied to the address electrode X of the plasma display panel through the data voltage application control switch Q1 of the data voltage application control unit 1810, a first node n1 and the top switch Qt of the data drive IC 1800.

Accordingly, the third pulse is maintained at the data voltage Vd during the maintaining period d2.

During the falling period d3 subsequent to the maintaining period d2, a gradually falling voltage is applied to the address electrode X of the plasma display panel.

During the falling period d3, the energy recovery control switch Q3 of the energy recovery control unit 1823 of the energy recovery circuit 1820 and the top switch Qt of the data drive IC 1800 are turned on.

Further, during the falling period d3, the energy application control switch Q2 of the energy application control unit 1821 of the energy recovery circuit 1820, the data voltage application control switch Q1 of the data voltage application control unit 1810 and the bottom switch Qb of the data drive IC 1800 are turned off.

As a result, as illustrated in FIG. 19d, the reactive energy recovered from the plasma display panel is applied to the energy storing capacitor C of the energy storing unit 1821 through the top switch Qt of the data drive IC 1800, the inductor 1824 and the energy recovery control switch Q3 of the energy recovery control unit 1823.

A voltage of the energy recovered from the address electrode X of the plasma display panel gradually falls with a predetermined slope by the LC resonance of the inductor 1824 during the falling period d3. In other words, a voltage of the third pulse gradually falls from the data voltage Vd to the ground level voltage.

After applying the data voltage Vd to the address electrode X as illustrated in FIG. 19d, the ground level voltage is applied to the address electrode X, as illustrated in FIG. 19e.

When the ground level voltage is applied to the address electrode X, as illustrated in FIG. 19e, the bottom switch Qb of the data drive IC 1800 is turned on. Further, the data voltage application control switch Q1 of the data voltage application control unit 1810, the energy application control switch Q2 and the energy recovery control switch Q3 of the energy recovery circuit 1820, and the top switch Qt of the data drive IC 1800 are turned off.

As a result, as illustrated in FIG. 19e, the ground level voltage is applied to the address electrode X through the bottom switch Qb of the data drive IC 1800.

The circuit of FIG. 18 performs the energy recovery function through the above-described switching operations such that the third pulse is applied to the address electrode X.

Since the third pulse is applied to the address electrode X through the circuit having the energy recovery function, power consumption decreases such that the driving efficiency is improved.

The plasma display panel to which the driving method according to the embodiment of the present invention is applied may be included in a PDP television set having a recording device for storing a video data and an audio data.

FIG. 20 illustrates a PDP television set comprising the plasma display panel to which the driving method according to the embodiment of the present invention is applied.

As illustrated in FIG. 20, a PDP television set comprises an antenna 2000, a tuner/demodulator 2010, a demultiplexer 2020, a video processing unit 2030, an video output unit 2040, an audio processing unit 2050, an audio output unit 2060, a control unit 2070, a personal video recorder (PVR) 2080 and a plasma display panel 2090 to which the driving method according to the embodiment of the present invention is applied. The PDP television set may be electrically connected to the PVR 2080.

The tuner/demodulator 2010 receives a broadcasting pulse through the antenna 2000, and then selects a broadcasting pulse in accordance with a television channel which a user selects.

The demultiplexer 2020 divides the broadcasting pulse selected by the tuner/demodulator 2010 in accordance with a property of the selected broadcasting pulse.

The video processing unit 2030 processes predetermined video information divided by the demultiplexer 2020 so that the video can be displayed on the screen.

The video output unit 2040 applies the video information processed by the video processing unit 2030 to the plasma display panel 2090 in the form of a driving pulse.

The plasma display panel 2090 displays a predetermined video in accordance with the driving pulse received from the video output unit 2040 on the screen.

Since the plasma display panel 2090 was described above in detail, a description thereof is omitted.

The audio processing unit 2050 processes predetermined audio information divided by the demultiplexer 2020 so that the user can listen to the predetermined audio information.

The audio output unit 2060 outputs a pulse processed by the audio processing unit 2050.

The PVR 2080 comprises a storing unit for storing audio information and video information such as hard disk drive (HDD). The audio information or the video information divided by the demultiplexer 2020 is stored in the storing unit of the PVR 2080.

The PVR 2080 may store the video information processed by the video processing unit 2030 or the audio information processed by the audio processing unit 2050.

The control unit 2070 controls the display of the video, the output of the audio, or the storage of the video information or the audio information, and the like.

In the PDP television set having the above-described configuration, when the antenna 2000 receives the broadcasting pulse, the tuner/demodulator 2010 receives the broadcasting pulse from the antenna 2000, and then selects the broadcasting pulse of a channel which the user selects in accordance with a control pulse of the control unit 2070.

The demultiplexer 2020 receives the broadcasting pulse selected by the tuner/demodulator 2010, and then divides the broadcasting pulse in accordance with the property of the selected broadcasting pulse. The predetermined video information, the predetermined audio information, additional information, and the like, divided by the demultiplexer 2020 are applied to the video processing unit 2030 and the audio processing unit 2050.

The video processing unit 2030 processes the applied predetermined video information so that the user can watch the applied predetermined video information as the video. The video information processed by the video processing unit 2030 is applied to the plasma display panel 2090 through the video output unit 2040. Accordingly, the video is displayed on the screen of the plasma display panel 2090.

The audio processing unit 2050 processes the applied predetermined audio information so that the user can listen to the predetermined audio information. The audio information processed by the audio processing unit 2050 is outputted through the audio output unit 2060 so that the user can listen to the processed audio information.

When the user wants to store the predetermined video information or the predetermined audio information, the predetermined video information or the predetermined audio information is stored in the PVR 2080 under the control of the control unit 2070.

Accordingly, the user can watch or listen to the video information or the audio information stored in the PVR 2080 at user's convenience.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a plasma display panel comprising a front substrate on which a scan electrode, a sustain electrode and an upper dielectric layer are formed, and a rear substrate on which an address electrode intersecting the scan electrode and the sustain electrode and a lower dielectric layer are formed, during a sub-field in a frame for displaying a image, comprising:
applying a first pulse in which an applied voltage varies with time until reaching a first voltage level to the scan electrode during a reset period, thereafter applying a second pulse in which an applied voltage varies with time until reaching a second voltage level to the scan electrode during the reset period wherein the second pulse has a polarity opposite to a polarity of the highest voltage level of the first pulse;
applying a third pulse corresponding to a data pulse to the address electrode through a first circuit comprising an inductor during an address period wherein the third pulse comprises a rising period and a maintaining period, and the rising period ranges from about 75 ns to about 800 ns;
applying a fourth pulse to the scan electrode during the address period, wherein a portion of the fourth pulse is overlapped with at least a portion of the third pulse, the lowest voltage level of the fourth pulse is lower than the lowest voltage level of the second pulse, and a voltage difference between the lowest voltage level of the fourth pulse and the lowest voltage level of the second pulse ranges from 5V to 50V;
applying a plurality of pulses to the scan electrode through a second circuit comprising at least one inductor during a sustain period for emitting light; and
applying a plurality of pulses to the sustain electrode through a third circuit comprising at least one inductor during the sustain period,
wherein the upper dielectric layer and the lower dielectric layer have Pb whose amount is equal to or less than 1000 ppm, respectively.

2. The method of claim 1, wherein a fifth is applied to the sustain electrode during the application of the first pulse in the reset period.

3. The method of claim 2, wherein the fifth pulse has a negative voltage level.

4. The method of claim 3, wherein the fifth pulse has a voltage varying with time.

5. The method of claim 3, wherein the voltage of the fifth pulse remains constant.

6. The method of claim 1, wherein at least one of the plurality of pulses applied to the sustain electrode during the sustain period is substantially synchronized with at least one of the plurality of pulses applied to the scan electrode during the sustain period.

7. The method of claim 1, wherein the scan electrode comprises a projecting portion
including a first portion, a second portion wider than a horizontal width of the first portion, and a third portion wider than the horizontal width of the second portion.

8. The method of claim 7, wherein the width of at least one of the first portion or the second portion gradually widens toward the middle portion of a discharge cell.

9. The method of claim 1, wherein the scan electrode comprises a bus electrode.

10. The method of claim 1, wherein an inner surface of the front substrate comprises a portion with a different thickness.

11. The method of claim 1, wherein a film-type filter is formed on an external surface of the front substrate.

12. The method of claim 1, wherein a black layer is formed between the scan electrodes OR between the sustain electrodes, or between the scan electrode and the sustain electrode.

13. The method of claim 12, wherein a portion of the scan electrode and a portion of the sustain electrode overlap the black layer.

14. The method of claim 1, wherein a dielectric layer comprising a portion with a different thickness is formed on the inner surface of the front substrate.

15. The method of claim 1, wherein at least one of the first, second or third circuits has an energy recovery function.

16. The method of claim 1, wherein the plasma display panel further comprises a barrier rib have Pb whose amount is equal to or less than 1,000 ppm.

17. A plasma display panel included in a PDP television set comprising or electrically connected to a harddisk drive for storing a video data and an audio data, comprising:
a scan electrode where a first p pulse is applied, wherein the first pulse has a voltage varying with time until reaching a first voltage level during a reset period,thereafter, a second pulse is applied wherein the second pulse has a voltage varying with time until reaching a second voltage level,a fourth pulse is applied during an address period, and a plurality of pulses are applied through a second circuit comprising at least one inductor during a sustain period for emitting light;
an address electrode where a third pulse corresponding to a data pulse is applied through a first circuit comprising an inductor during the address period, wherein the third pulse comprises a rising period and a maintaining period, and the rising period ranges from about 75 ns to about 800 ns; and
a sustain electrode where a plurality of pulses are applied through a third circuit comprising at least one inductor during the sustain period,
wherein a polarity of the first pulse is opposite to a polarity of the second pulse,
a portion of the fourth pulse is overlapped with at least a portion of the third pulse,
the lowest voltage level of the fourth pulse is lower than the lowest voltage level of the second pulse, and
a difference between the lowest voltage level of the fourth pulse and the lowest voltage level of the second pulse ranges from 5V to 50V.

18. The plasma display panel of claim 17, wherein the scan electrode comprises a projecting portion, and
the projecting portion comprises a first portion, a second portion wider than a horizontal width of the first portion, and a third portion wider than the horizontal width of the second portion.

19. The plasma display panel of claim 17, wherein the scan electrode comprises a bus electrode.
